(19) United States
(12) Patent Application Publication
(10) Pub. No.: US 2025/0219884 A1
(43) Pub. Date: Jul. 3, 2025

(54) PAPR REDUCTION FOR MIMO TRANSMISSION

(71) Applicant: Telefonaktiebolaget LM Ericsson (publ), Stockholm (SE)

(72) Inventors: Pierre-Andre LAPORTE, GATINEAU Quebec (CA); Milad FOZOONI, Göteborg (SE); Petter ERSBO, Knivsta (SE)

(73) Assignee: Telefonaktiebolaget LM Ericsson (publ), Stockholm (SE)

(21) Appl. No.: 18/847,991

(22) PCT Filed: Mar. 18, 2022
(86) PCT No.: PCT/EP2022/057146

§ 371 Date: Sep. 17, 2024

(51) Int. Cl. H04L 27/26; H04B 7/0413; H04B 7/06

(52) U.S. Cl. CPC H04L 27/2614; H04B 7/0413; H04B 7/0617

(57) ABSTRACT

A method is disclosed for reduction of peak-to-average power ratio (PA-PR) of transmission using multiple-input multiple-output (MIMO) from a transmitter. The method comprises defining a rank-extended MIMO transmission towards one or more intended receivers and one or more virtual receivers (wherein the one or more virtual receivers reside in a null space of a MIMO channel between the transmitter and the one or more intended receivers), generating a rank-extended MIMO signal for the rank-extended MIMO transmission (wherein the rank-extended MIMO signal comprises an intended receiver signal portion and a virtual receiver signal portion), determining a clipping signal for the rank-extended MIMO signal, and generating a PAPR reduced MIMO signal by combining the rank-extended MIMO signal with a projection of the clipping signal onto the null space of the MIMO channel. In some embodiments, the method further comprises transmitting the PAPR reduced MIMO signal over the MIMO channel. Corresponding computer program product, apparatus, radio access node, user device, control node, and system are also disclosed.

### TECHNICAL FIELD

The present disclosure relates generally to the field of wireless communication. More particularly, it relates to reduction of peak-to-average power ratio (PAPR) for multiple-input multiple-output (MIMO) transmissions.

### BACKGROUND

Multiple-input multiple-output (MIMO) transmission is well known in the art of wireless communication. For example, fifth generation (5G) wireless communication systems applies MIMO (more particularly massive-MIMO) to enable high spectral efficiency.

Application of massive-MIMO is closely related to radio access node implementation. For example, a large number of antenna elements is typically required for massive-MIMO, which may entail an equally large number of transceiver chains (at least for digital beamforming).

A large number of transceiver chains may be associated with complexity challenges. For example, hardware size can be unacceptable large and/or power consumption can become unacceptably high. These problems may, at least to some extent, be due to high peak-to-average power ratio (PAPR).

Many systems employ orthogonal frequency division multiplexing (OFDM). A drawback of OFDM is that the OFDM signal may, typically, have relatively high PAPR.

One approach to addressing these problems is application of PAPR reduction. PAPR reduction may be implemented by PAPR reduction precoding—also known as massive-MIMO crest factor reduction (CFR). Such techniques enable reduction of the dynamic range of the signal intended for transmission (e.g., an OFDM signal) by taking advantage of the large number of degrees of freedom that are typically available in massive-MIMO systems.

The ability to achieve a sufficiently low PAPR provides several advantages. For example, a sufficiently low PAPR may render digital pre-distortion (DPD) unnecessary, or provide for relatively low DPD complexity. Alternatively or additionally, a sufficiently low PAPR may enable use of relatively small power amplifiers (PAs), and/or PAs with relatively low power consumption. Yet alternatively or additionally, a sufficiently low PAPR may enable use of relatively small cooling sub-systems. Yet alternatively or additionally, a sufficiently low PAPR may enable use of data converters with relatively low resolution.

One precoding approach for PAPR reduction is called convex reduction of amplitudes (CRAM). For example, WO 2019/069117 A1 describes PAPR reduction in a massive-MIMO OFDM transmitter system, including processing of frequency-domain precoded signals in accordance with a multi-carrier CRAM processing scheme.

A problem with these approaches is that the PAPR reduction provided is insufficient, or even non-existent, in some scenarios.

Therefore, there is a need for alternative approaches to PAPR reduction for MIMO transmission.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for reduction of peak-to-average power ratio (PAPR) of transmission using multiple-input multiple-output (MIMO) from a transmitter.

The method comprises defining a rank-extended MIMO transmission towards one or more intended receivers and one or more virtual receivers, wherein the one or more virtual receivers reside in a null space of a MIMO channel between the transmitter and the one or more intended receivers, and generating a rank-extended MIMO signal for the rank-extended MIMO transmission, wherein the rank-extended MIMO signal comprises an intended receiver signal portion and a virtual receiver signal portion.

The method also comprises determining a clipping signal for the rank-extended MIMO signal, and generating a PAPR reduced MIMO signal by combining the rank-extended MIMO signal with a projection of the clipping signal onto the null space of the MIMO channel.

In some embodiments, the method further comprises transmitting the PAPR reduced MIMO signal over the MIMO channel.

In some embodiments, respective directions from the transmitter towards the one or more virtual receivers are different.

In some embodiments, respective directions from the transmitter towards the one or more virtual receivers are variable between different subcarriers.

In some embodiments, respective directions from the transmitter towards the one or more virtual receivers avoid a direction from the transmitter towards an interference sensitive device.

In some embodiments, at least one of the one or more virtual receivers resides in a direction from the transmitter towards an energy harvesting device.

In some embodiments, the null space of the MIMO channel is representable by a vector basis, and defining the rank-extended MIMO transmission comprises (for each of the one or more virtual receivers) selecting one or more base vectors from the vector basis for beamforming of signal components for the corresponding virtual receiver.

In some embodiments, the null space of the MIMO channel is representable by a vector basis associated with a projection matrix, and defining the rank-extended MIMO transmission comprises—responsive to the projection matrix being rank-deficient—generating an alternative vector basis for the null space and (for each of the one or more virtual receivers) selecting one or more base vectors from the alternative vector basis for beamforming of signal components of the corresponding virtual receiver.

In some embodiments, the selection of one or more base vectors is variable between the one or more virtual receivers and/or between different subcarriers.

In some embodiments, the virtual receiver signal portion comprises one or more of: default traffic, random traffic, and copied traffic intended for the one or more intended receivers.

In some embodiments, the method is executed only when the MIMO channel fulfills a frequency flatness condition.

In some embodiments, a number of virtual receivers increases when magnitude variance between frequencies of the MIMO channel decreases.

In some embodiments, power allocated to the one or more virtual receivers increases when magnitude variance between frequencies of the MIMO channel decreases.

In some embodiments, power allocated to the one or more virtual receivers increases when power allocated to the one or more intended receivers decreases.

In some embodiments, power allocated to the one or more virtual receivers is variable between the one or more virtual receivers and/or between different subcarriers.

In some embodiments, the PAPR reduced MIMO signal is generated by combining the rank-extended MIMO signal with the projection of the clipping signal onto the null space of the MIMO channel, and with a projection—scaled by a weighting factor—of the clipping signal onto a signal space of the MIMO channel.

In some embodiments, the weighting factor increases when a minimum distance between symbols of a coding and modulation alphabet increases.

In some embodiments, the weighting factor increases when magnitude variance between frequencies of the MIMO channel decreases.

In some embodiments, the weighting factor is variable between the one or more intended receivers and/or between different subcarriers.

In some embodiments, the weighting factor and power allocated to the one or more virtual receivers are selected jointly.

In some embodiments, the joint selection also comprises selection of maximal magnitude of the clipping signal.

In some embodiments, the maximal magnitude of the clipping signal decreases when magnitude variance between frequencies of the MIMO channel decreases.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for reduction of peak-to-average power ratio (PAPR) of transmission using multiple- input multiple-output (MIMO) from a transmitter.

The apparatus comprises controlling circuitry configured to cause definition of a rank-extended MIMO transmission towards one or more intended receivers and one or more virtual receivers, wherein the one or more virtual receivers reside in a null space of a MIMO channel between the transmitter and the one or more intended receivers, and generation of a rank-extended MIMO signal for the rank-extended MIMO transmission, wherein the rank-extended MIMO signal comprises an intended receiver signal portion and a virtual receiver signal portion.

The controlling circuitry is also configured to cause determination of a clipping signal for the rank-extended MIMO signal, and generation of a PAPR reduced MIMO signal by combining the rank-extended MIMO signal with a projection of the clipping signal onto the null space of the MIMO channel.

A fourth aspect is a radio access node comprising the apparatus of the third aspect.

A fifth aspect is a user device comprising the apparatus of the third aspect.

A sixth aspect is a control node comprising the apparatus of the third aspect.

A seventh aspect is a system comprising a radio access node and a control node according to the sixth aspect, wherein the control node is configured to control the radio access node for PAPR reduction of MIMO transmission from a transmitter of the radio access node.

In some embodiments, any of the above aspects may additionally have features identical with or corresponding to any of the various features as explained above for any of the other aspects.

An advantage of some embodiments is that alternative approaches to PAPR reduction for MIMO transmission are provided.

An advantage of some embodiments is that PAPR reduction is provided to a higher degree compared to other approaches.

An advantage of some embodiments is that PAPR reduction is provided without substantial degradation of the error vector magnitude (EVM) for the transmission.

An advantage of some embodiments is that the PAPR reduction performance of massive-MIMO CFR under frequency-flat fading channel conditions is improved compared to conventional approaches (which typically fail to reduce the PAPR sufficiently, or at all, in such channel conditions; and sometimes even worsen the PAPR).

An advantage of some embodiments is that the presented approaches can be used also for spatially rich channels. Then, the PAPR may be reduced more than what is possible with conventional approaches of massive-MIMO CFR.

An advantage of some embodiments is that the clipping noise can be suitably directed. For example, the clipping noise can be away from interference sensitive devices (e.g., satellite earth stations, other radio access nodes, etc.). Alternatively or additionally, the clipping noise can be directed towards an energy harvesting device (typically another device than an intended receiver of the information carried by the transmitted signal).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIGS. 2A-C are a collection of schematic drawings illustrating example principles according to some embodiments;

FIG. 3 is a schematic block diagram illustrating an example apparatus according to some embodiments;

FIG. 4 is a schematic block diagram illustrating an example apparatus according to some embodiments;

FIG. 5 is a schematic block diagram illustrating an example apparatus according to some embodiments;

FIG. 6 is a schematic block diagram illustrating an example system according to some embodiments; and

FIG. 7 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described wherein alternative approaches to PAPR reduction for MIMO transmission are provided. Some embodiments may be seen as virtual auxiliary node (VAN) assisted crest factor reduction (CFR).

As already mentioned, a problem with existing approaches to PAPR reduction for MIMO transmission is that the PAPR reduction provided is insufficient, or even non-existent, in some scenarios. For example, when the channel conditions provide frequency-flat fading and/or a relatively low number of degrees of freedom (e.g., a relatively low number of signal paths and/or a relatively low number of beamformed transmission directions; one example being channels dominated by line-of-sight—LoS), PAPR reduction may be insufficient when existing approaches are applied.

To address insufficient PAPR reduction, some embodiments introduce one or more virtual receiver(s) (also referred to as a virtual auxiliary node(s) into the null space of the MIMO channel. The introduction of virtual receiver(s) may be seen as a fictional construction for describing utilization of one or more additional, artificial, MIMO layers to richen the channel for PAPR reduction. The additional MIMO layers are utilized to carry clipping signaling, and reside in the null space of the MIMO channel to avoid clipping signaling disturbance for intended receiver(s). For example, the additional MIMO layers may be beamformed using eigenvectors of the null space of the MIMO channel.

Thus, some embodiments provide approaches that assist massive-MIMO CFR algorithms to perform well under frequency-flat fading channel conditions; a scenario where conventional massive-MIMO CFR algorithms typically fail to reduce PAPR sufficiently (or at all), and may even increase the PAPR in some situations.

According to some embodiments, the presented approaches can also be used with spatially rich channels; whereby PAPR may be reduced further than what is possible with conventional massive-MIMO CFR algorithms.

Generally, when a radio access node is referred to herein, it is meant to include any suitable node for providing communication radio access. For example, a radio access node may be a base station, a gNodeB, an open radio access network (O-RAN) radio unit (O-RU), an access point (AP), etc.

Also generally, when a user device is referred to herein, it is meant to include any suitable wireless communication device for a user. For example, a user device may be a user equipment (UE), a station (STA), etc.

Also generally, when control node is referred to herein, it is meant to include any suitable node for communication control. For example, a communication node may be a central network node, a cloud server, an edge computing node, etc.

Furthermore, it should be noted that embodiments may be equally relevant for any communication context where PAPR reduction and MIMO transmission is applied. For example, embodiments may be applicable in relation to any suitable radio access approach (e.g., communication according to IEEE 802.11, according to standardization as advocated by the Third Generation Partnership Project, 3GPP, etc.). Alternatively or additionally, embodiments may be applicable in relation to any suitable channel conditions (e.g., line-of-sight—LoS—conditions, frequency-flat fading conditions, multi-path channel conditions, etc.).

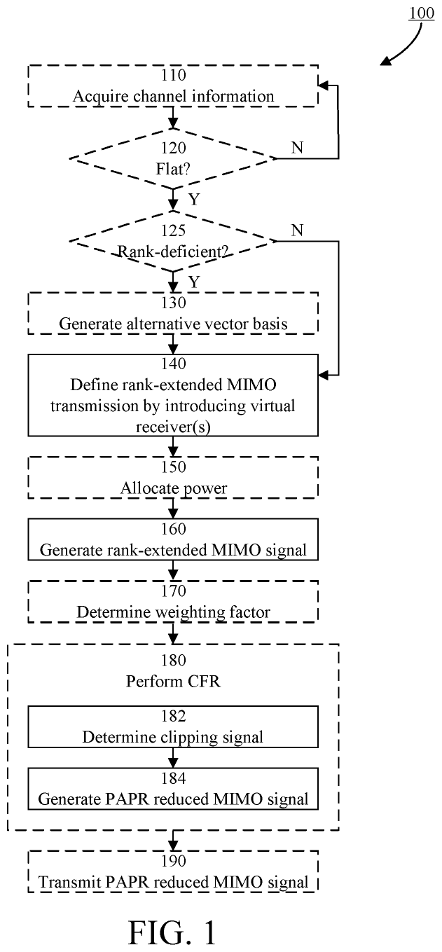

FIG. 1 illustrates an example method 100 according to some embodiments. The method 100 is for reduction of peak-to-average power ratio (PAPR) of transmission using multiple-input multiple-output (MIMO) from a transmitter. In some embodiments, the method 100 may be performed by a communication device that comprises the transmitter (e.g., a radio access node or a used device). In some embodiments, at least part of the method 100 may be performed by a communication device that does not comprise the transmitter (e.g., a control node).

The method comprises defining a rank-extended MIMO transmission towards one or more intended receivers and one or more virtual receivers, as illustrated by step 140. This may be achieved by letting the one or more virtual receivers reside in a null space of a MIMO channel between the transmitter and the one or more intended receivers. For example, a virtual receiver may be placed in a direction from the transmitter that is not a direction for beamformed transmission to any intended receiver.

Thereby, the MIMO channel between the transmitter and the one or more intended receivers is complemented (for the MIMO transmission) by MIMO channel portions between the transmitter and the one or more virtual receivers. Thus, the channel is richened (in terms of number of degrees of freedom: e.g., number of signal paths, number of beamformed transmission directions, number of MIMO layers, frequency-selectivity, etc.) by introduction of the one or more virtual receivers.

To this end, the method 100 is particularly suitable for channels with relatively few degrees of freedom (e.g., few signal paths—such as LoS conditions, few beamformed transmission directions, few of MIMO layers, etc.); but is not limited thereto.

An intended receiver may be defined as a receiver, to which information carried by the signal to be transmitted is directed. A virtual receiver (also referred to as a virtual auxiliary node, VAN) may be defined as a fictional receiver—e.g., comprised in a fictional user device. Thus, a virtual receiver is not an intended receiver of the signal to be transmitted. However, the direction from the transmitter towards a virtual receiver may coincide (or be substantially equal to) a direction from the transmitter to a receiver that may benefit from the transmission (e.g., an energy harvesting device) as will be exemplified in the following. This is not to be interpreted as the receiver benefitting from the transmission being a virtual receiver.

Generally, the null space of the MIMO channel is representable by a vector basis (which may be seen as associated with a projection matrix).

In this respect, defining the rank-extended MIMO transmission in step 140 may comprise (for each of the one or more virtual receivers) selecting one or more base vectors from the vector basis for beamforming of signal components for the corresponding virtual receiver.

When the projection matrix is rank-deficient, the method 100 may comprise generating an alternative vector basis for the null space before, or as part of, defining the rank-extended MIMO transmission. For example, the alternative vector basis may be generated by eigen-decomposition of the projection matrix. Then, defining the rank-extended MIMO transmission in step 140 may comprise (for each of the one or more virtual receivers) selecting one or more base vectors from the alternative vector basis for beamforming of signal components for the corresponding virtual receiver.

This is illustrated by optional steps 125 and 130. In step 125, it is determined whether the projection matrix is rank-deficient. If the projection matrix is rank-deficient (Y-path out of step 125), an alternative vector basis for the null space is generated in step 130 before proceeding to step 140. If the projection matrix is not rank-deficient (N-path out of step 125), the method proceeds directly to step 140.

As will be understood from the following, the signal components for the virtual receiver(s) typically comprise a virtual receiver signal portion of a rank-extended MIMO signal, and a projection of a clipping signal onto the null space of the MIMO channel. For a particular virtual receiver, the signal components may be the virtual receiver signal portion for the particular virtual receiver and a projection of the clipping signal onto the space spanned by the basis vectors selected for the particular virtual receiver.

The selection of base vector(s) from the vector basis (or from the alternative vector basis) may be variable between different virtual receivers. This may enable increased richening of the MIMO channel.

Alternatively or additionally, the selection of base vector(s) from the vector basis (or from the alternative vector basis) may be variable between different subcarriers. This may emulate frequency-selectivity of the channel.

Generally, non-linear operations is beneficial for PAPR reduction (e.g., in massive-MIMO CFR) because the non-linearity enables spreading of clipping noise in different directions as well as in the null space. In a frequency flat scenario (e.g., in LOS conditions), the clipping operation is reduced to a linear operation, which entails that it is not possible to properly spread the clipping noise. This is particularly prominent for rank-1 transmission.

Shuffling of the null space and/or of eigenvectors (e.g., by letting directions towards virtual receivers vary between subcarriers, and/or by letting selected base vectors vary between virtual receivers and/or between subcarriers) may cause the clipping to behave nonlinearly. The method also comprises generating a rank-extended MIMO signal for the rank-extended MIMO transmission, as illustrated by step 160. The rank-extended MIMO signal comprises an intended receiver signal portion and a virtual receiver signal portion.

Typically, the intended receiver signal portion corresponds to a signal initially intended for transmission, carrying information for the intended receiver(s). The virtual receiver signal portion typically corresponds to a signal associated with the virtual receiver(s). For example, the virtual receiver signal portion may comprise default traffic, random traffic, copied traffic for the intended receiver(s), or any combination thereof.

Step 160 may, for example, comprise combining (e.g., by addition, accumulation, super-position, concatenation, or similar) the intended receiver signal portion with the virtual receiver signal portion.

Before execution of step 160, the method may also comprise allocating power to the virtual receiver(s), as illustrated by optional step 150. Generally, allocating more power to virtual receivers enables better PAPR reduction.

The power allocated to the virtual receiver(s) may be fixed or variable. For example, the total power allocated to the virtual receiver(s) may be fixed, or the power allocated per virtual receiver may be fixed, or the total power as well as the power allocated per virtual receiver may be variable.

Typically, the power allocated to the virtual receivers may increase when the power allocated to the intended receivers decreases (i.e., when there is more power available for virtual receivers). For example, when one, or most, or all, of the intended receivers is relatively close to the transmitter, the power allocated to the intended receivers may be relatively low and more transmission power may be available for virtual receivers.

In some scenarios, the PAPR is reduced when the power allocated to the virtual receivers may increases. When PAPR is reduced, it is possible to increase the average transmitted power (e.g., since less back-off may be required). Hence, increasing the power allocated to virtual receivers may enable the average transmitted power to be increased, thereby enabling increase also of the power allocated to the intended receivers. Alternatively or additionally, reduced PAPR may offer benefits in terms of power amplifier (PA) energy efficiency of the PA.

Different virtual receivers may be allocated the same, or different, power. In some embodiments, the power allocated to the virtual receivers is variable between different OFDM subcarriers. This may emulate frequency-selectivity of the channel and cause the clipping to behave nonlinearly.

The method also comprises determining a clipping signal for the rank-extended MIMO signal and generating a PAPR reduced MIMO signal, as illustrated by steps 182 and 184. As illustrated by optional step 180 incorporating steps 182 and 184, the determination of the clipping signal and the generation of the PAPR reduced MIMO signal may, for example, be implemented using any suitable CFR approach (e.g., CRAM).

The clipping signal is typically determined based on the rank-extended MIMO signal (i.e., based on a combination of the intended receiver signal portion and the virtual receiver signal portion). The clipping signal may be configured to reduce the PAPR of the rank-extended MIMO signal. Determination of the clipping signal may be achieved using polar clipping or any other suitable clipping approach. Alternatively or additionally, the clipping signal may be achieved using hard clipping, soft clipping, donut clipping (clipping from above and below), or any other suitable clipping approach. Typically, a maximal magnitude of the clipping signal (a.k.a. a clipping threshold) may be used as a limiting condition in the determination of the clipping signal. The maximal magnitude of the clipping signal may be fixed or variable.

The PAPR reduced MIMO signal is generated by combining the rank-extended MIMO signal with a projection of the clipping signal onto the null space of the MIMO channel.

In some embodiments, the PAPR reduced MIMO signal consists of the rank-extended MIMO signal and the projection of the clipping signal onto the null space of the MIMO channel. Thereby, the part of the PAPR reduced MIMO signal that reaches the intended receivers is unaffected by the clipping signal.

In some embodiments, the PAPR reduced MIMO signal is generated by combining the rank-extended MIMO signal with the projection of the clipping signal onto the null space of the MIMO channel, and with a projection—scaled by a weighting factor, i.e., a weighted projection—of the clipping signal onto a signal space of the MIMO channel. Thus, the PAPR reduced MIMO signal may comprise the rank-extended MIMO signal, the projection of the clipping signal onto the null space of the MIMO channel, and the weighted projection of the clipping signal onto the signal space of the MIMO channel. The weighted projection of the clipping signal onto the signal space of the MIMO channel may be seen as leakage of the clipping signal onto the signal space of the MIMO channel.

The leakage of the clipping signal may enable improved PAPR reduction since the clipping signal is less distorted. Alternatively or additionally, the leakage of the clipping signal may enable use of lower power allocation to the virtual receiver(s). Typically, leakage of the clipping signal comes at the cost of increased EVM for the intended receiver(s).

The weighting factor typically has a value between zero and one. The weighting factor may be fixed or variable. When variable, it may be determined prior to the generation of the PAPR reduced MIMO signal, as illustrated by optional step 170.

In some embodiments, the weighting factor is variable between different intended receivers and/or between different subcarriers. This may enable application of a relatively high leakage for an intended receiver and/or a subcarrier with poor reception conditions (e.g., relatively low signal-to-interference ratio, SIR), and application of a relatively low, or no, leakage for an intended receiver and/or a subcarrier with good reception conditions (e.g., relatively high SIR). For good reception conditions, a high order modulation order is typically used which is sensitive to EVM. Therefore, high leakage may be problematic under such conditions. For poor reception conditions, a robust modulation order is typically used which is less sensitive to EVM. Therefore, high leakage is typically not problematic under such conditions; having negligible impact compared to other disturbances.

Alternatively or additionally, the weighting factor may increase when a minimum distance between symbols of a coding and modulation alphabet increases. For example, the minimum distance between symbols of the coding and modulation alphabet may be determined based on a combination of Hamming distance between codewords and Euclidean distance between modulation symbols. In some embodiments, a pre-determined mapping between modulation and coding scheme (MCS) and weighting factor is applied. This may enable application of a relatively high leakage for robust modulation and coding (e.g., a MCS with a relatively long minimum distance), and application of a relatively low, or no, leakage for less robust modulation and coding (e.g., a MCS with a relatively short minimum distance).

As illustrated by optional step 190, the method 100 may further comprise transmitting the PAPR reduced MIMO signal over the MIMO channel.

The transmission of the PAPR reduced MIMO signal may comprise beamforming respective parts of the intended receiver signal portion, the virtual receiver signal portion, and the projection of the clipping signal to corresponding receiver(s). For example, respective part(s) of the intended receiver signal portion may be beamformed to the corresponding intended receiver(s), and respective part(s) of the virtual receiver signal portion combined with the projection of the clipping signal may be beamformed to the corresponding virtual receiver(s).

Generally, the beamforming to a receiver may correspond to the direction from the transmitter towards the receiver. Also generally, the direction from the transmitter towards a receiver may comprise a LOS direction and/or a direction of a reflection path.

Generally, the MIMO transmission may comprise transmission of an OFDM signal. For example, at least the intended receiver signal portion may be an OFDM signal. Alternatively or additionally, the rank-extended MIMO signal may be an OFDM signal.

When step 140 comprises placing the one or more virtual receivers in respective direction(s) from the transmitter, the directions may generally be selected according to any suitable approach (e.g., randomly); possibly under one or more selection conditions.

For example, according to one condition for direction selection, the direction from the transmitter towards a virtual receiver should be different from all directions from the transmitter towards the intended receivers. This may enable the virtual receiver to reside in the null space of the MIMO channel.

Alternatively or additionally, according to one condition for direction selection, respective directions from the transmitter towards different virtual receivers should be different. This may enable increased richening of the MIMO channel.

Yet alternatively or additionally, according to one condition for direction selection, the direction from the transmitter towards a virtual receiver should be variable between different OFDM subcarriers. This may emulate frequency-selectivity of the channel and cause the clipping to behave nonlinearly.

Yet alternatively or additionally, according to one condition for direction selection, the direction from the transmitter towards a virtual receiver should avoid a direction from the transmitter towards an interference sensitive device (e.g., a satellite earth station, a radio access node which comprises neither the transmitter nor any of the intended receiver(s), etc.). This may enable the MIMO transmission taking place without causing excessive interference.

Yet alternatively or additionally, according to one condition for direction selection, the direction from the transmitter towards a virtual receiver should correspond to (e.g., be equal—or substantially equal—to) a direction from the transmitter towards an energy harvesting device. This may enable at least some of the energy directed away from the intended receiver(s) being utilized also for other purposes than PAPR reduction.

Alternatively or additionally, according to one condition for direction selection, the direction from the transmitter towards a virtual receiver should correspond to a direction from the transmitter towards an physical/spatial mask. This can filter some part of the clipped-noise and avoid undesirable signal contamination.

In some embodiments, the rank-extension is applied only when the MIMO channel fulfills a frequency flatness condition (e.g., defining a condition for frequency-flat fading). This is illustrated by optional steps 110 and 120 in FIG. 1.

In step 110, channel information is acquired (e.g., by performing channel measurements, and/or receiving channel measurement report(s) from the intended receiver(s)). In step 120, it is determined whether the frequency flatness condition is fulfilled.

When the frequency flatness condition is fulfilled (Y-path out of step 120) the remainder of the method 100 is executed. When the frequency flatness condition is not fulfilled (N-path out of step 120) the remainder of the method 100 is not executed, which is illustrated in FIG. 1 by a return path to step 110. Although not shown in FIG. 1, it should be understood that other actions may be performed when the frequency flatness condition is not fulfilled. For example, a conventional massive-MIMO CFR approach may be applied for MIMO transmission.

The frequency flatness condition may comprise any suitable condition. For example, a frequency flatness metric may be compared to a threshold value. Then, the frequency flatness condition may be fulfilled when the frequency flatness metric falls on a first side of the threshold value that corresponds to relatively flat channels (e.g., when the frequency flatness metric does not exceed the threshold value), and the frequency flatness condition may be not fulfilled when the frequency flatness metric falls on a second side of the threshold value that does not correspond to relatively flat channels (e.g., when the frequency flatness metric exceeds the threshold value). An example frequency flatness metric may be, or may be based on, a magnitude and/or phase variance between frequencies for the channel.

Acquisition of channel information as illustrated by step 110 may, alternatively or additionally, be relevant for other purposes than switching on and off the rank-extension according to step 120. For example, as will be exemplified in the following, the channel information may be used to control one or more of: the number of virtual receivers, the power allocated to the one or more virtual receivers, a weighting factor for leakage of the clipping signal onto a signal space of the MIMO channel, and a maximal magnitude of the clipping signal.

In some embodiments, the number of virtual receivers is fixed (e.g., equal to one). In other embodiments, the number of virtual receivers increases with frequency flatness of the channel. For example, the number of virtual receivers may increase when the magnitude variance between frequencies of the MIMO channel decreases. This may enable dynamic trade-off between PAPR reduction performance and overhead due to the virtual receiver(s) (e.g., transmission power allocated to virtual receiver(s)). In some embodiments, the threshold comparison described above for step 120 may be seen as a special case of increasing the number of virtual receivers with frequency flatness of the channel. Alternatively or additionally, determination of the number of virtual receivers may be performed as part of step 140.

In some embodiments, the power allocated to the virtual receiver(s) in step 150 increases with frequency flatness of the channel. For example, the power allocated to the virtual receiver(s) may increase when magnitude variance between frequencies of the MIMO channel decreases. This may enable dynamic trade-off between PAPR reduction performance and overhead due to the virtual receiver(s) in the form of transmission power allocated to virtual receiver(s).

In some embodiments, the weighting factor determined in step 170 increases with frequency flatness of the channel. For example, the weighting factor may increase when magnitude variance between frequencies of the MIMO channel decreases. This may enable dynamic trade-off between PAPR reduction performance and EVM for the intended receiver(s).

In some embodiments, the maximal magnitude of the clipping signal determined in step 182 decreases with frequency flatness of the channel. For example, the maximal magnitude of the clipping signal may decrease when magnitude variance between frequencies of the MIMO channel decreases. This may enable dynamic trade-off between PAPR reduction performance and drawbacks due to PAPR reduction (e.g., transmission power allocated to virtual receiver(s) and/or EVM for the intended receiver(s) due to leakage).

In some embodiments, two or more of: the power allocated to the one or more virtual receivers, the weighting factor for leakage, and the maximal magnitude of the clipping signal are selected jointly. For example, joint selection could comprise selecting one of a collection of combinations that have been predetermined as allowable. The predetermination may, for example, be achieved by evaluation of all, or a subset of all, possible combinations (e.g., for some typical scenarios of the MIMO channel). The evaluation might comprise performing simulations and/or solving constrained optimization problems.

As already mentioned, at least part of the method 100 may be performed by a communication device that does not comprise the transmitter (e.g., a control node) according to some embodiments. For example, a control node may perform steps 140, 160, 182, 184, and cause a radio access node to perform step 190 (e.g., by providing the PAPR reduced MIMO signal to the radio access node), or a control node may perform steps 140, 160, and cause a radio access node to perform steps, 182, 184, 190 (e.g., by providing the rank-extended MIMO signal to the radio access node).

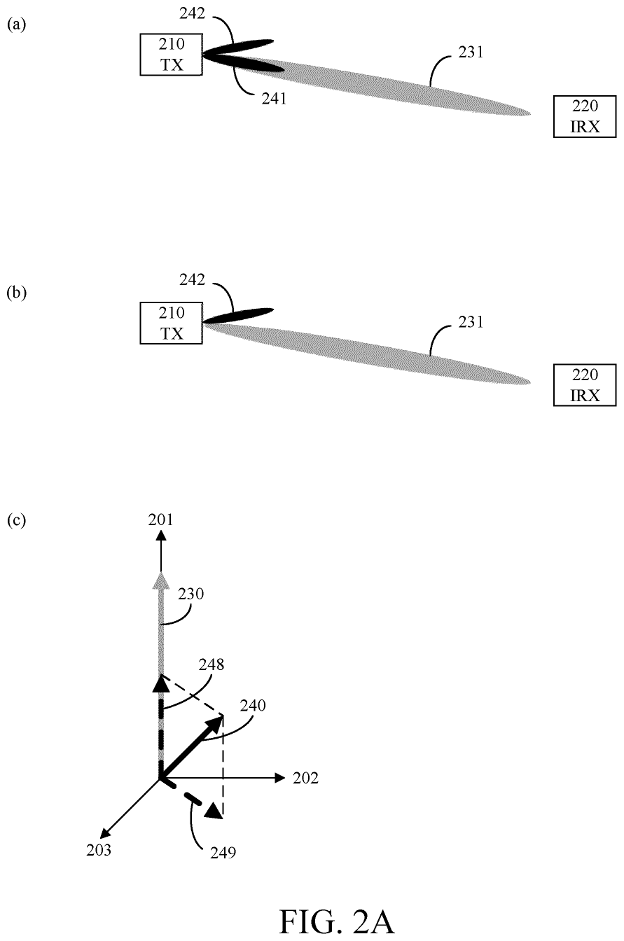

FIGS. 2A-C are a collection of schematic drawings illustrating example principles of PAPR reduction for MIMO channels. The example principles are illustrated for a transmitter (TX) 210 and an intended receiver (IRX) 220.

FIG. 2A schematically illustrates example principles of PAPR reduction for a MIMO channel which is relatively rich because there is more than one signal path available for transmission (i.e., more than one possible beamformed transmission direction).

Part (a) of FIG. 2A illustrates a MIMO signal 231 on a beam directed towards the intended receiver, and a corresponding clipping signal for PAPR reduction of the MIMO signal. The clipping signal comprises two parts 241, 242 on respective beams.

A first part of the clipping signal 241, which is a projection of the clipping signal onto the sub-space of the MIMO channel that the MIMO signal occupies, appears on the same beam as the MIMO signal 231. A second part of the clipping signal 242, which is a projection of the clipping signal onto the sub-signal space of the MIMO channel that the MIMO signal does not occupy, appears on a different beam than the MIMO signal 231.

Part (b) of FIG. 2A illustrates a PAPR reduced MIMO signal for transmission. The PAPR reduced MIMO signal is a combination of the MIMO signal 231 and the second part of the clipping signal 242.

The signal combination of part (a) of FIG. 2A provides high PAPR reduction (due to inclusion of both parts 241, 242 of the clipping signal) but also high EVM for the intended receiver (due to the first part 241 of the clipping signal causing disturbance to the MIMO signal 231).

The signal combination of part (b) of FIG. 2A provides reasonably high PAPR reduction (due to inclusion of the second part 242 of the clipping signal) and no EVM for the intended receiver (due to no part of the clipping signal causing disturbance to the MIMO signal 231).

Thus, the approach exemplified by part (b) or FIG. 2A may be advantageous for transmission. Put more generally, this approach may be described as determining a clipping signal for the MIMO signal and generating a PAPR reduced MIMO signal by combining the MIMO signal with a projection of the clipping signal onto the sub-signal space of the MIMO channel that not occupied by the MIMO signal.

Part (c) of FIG. 2A illustrates the principles of parts (a) and (b) of FIG. 2A in a schematic representation of the MIMO channel. The schematic representation of the MIMO channel has two dimensions; illustrated in a three-dimensional space spanned by corresponding basis vectors 201, 202, 203. The MIMO signal 231 occupies the dimension spanned by basis vector 201, as illustrated by 230. The clipping signal 240 comprises a first part 241 and a second part 242. The first part 241 is a projection onto the sub-space of the MIMO channel that the MIMO signal occupies, as illustrated by 248. The second part 242 is a projection onto the sub-space of the MIMO channel that the MIMO signal does not occupy, as illustrated by 249. Thus, the MIMO signal 230 and the second part 249 of the clipping signal may be orthogonally transmitted to achieve reasonably high PAPR reduction without any EVM for the intended receiver.

FIG. 2B schematically illustrates example principles of PAPR reduction for a MIMO channel having only one signal path available for transmission (i.e., only one possible beamformed transmission direction), which may be seen as an exemplification of a frequency-flat channel.

Part (a) of FIG. 2B illustrates a MIMO signal 231 on a beam directed towards the intended receiver, and a corresponding clipping signal for PAPR reduction of the MIMO signal. Since the MIMO channel has only one signal path available for transmission, the clipping signal consists of one part 251 (which may be seen as a form of projection of the clipping signal onto the sub-space of the MIMO channel that the MIMO signal occupies), which appears on the same beam as the MIMO signal 231. A projection of the clipping signal onto the sub-signal space of the MIMO channel that the MIMO signal does not occupy is void (i.e., the clipping signal is projected onto zero) because there is no clipping energy in that sub-signal space of the MIMO channel.

Part (b) of FIG. 2B illustrates the result of an attempted PAPR reduction of the MIMO signal, wherein the MIMO signal 231 is combined with the (void) projection of the clipping signal onto the sub-signal space of the MIMO channel that the MIMO signal does not occupy.

The signal combination of part (a) of FIG. 2B provides high PAPR reduction (due to inclusion of the clipping signal 251) but also high EVM for the intended receiver (due to the clipping signal 251 causing disturbance to the MIMO signal 231).

The signal combination of part (b) of FIG. 2B provides no PAPR reduction (due to the clipping signal being completely removed by projection) and no EVM for the intended receiver (due to no clipping signal causing disturbance to the MIMO signal 231).

Thus, it is problematic to use the advantageous approach of FIG. 2A in the context of non-rich MIMO channels.

Part (c) of FIG. 2B illustrates the principles of parts (a) and (b) of FIG. 2B in a schematic representation of the MIMO channel. The schematic representation of the MIMO channel has a single dimension; illustrated in a three-dimensional space spanned by corresponding basis vectors 201, 202, 203. The MIMO signal 231 occupies the dimension spanned by the basis vector 201, as illustrated by 230. The clipping signal also resides entirely in the dimension spanned by the basis vector 201, as illustrated by 250. A projection of the clipping signal 250 onto the sub-space of the MIMO channel that the MIMO signal occupies constitutes an identity function. A projection of the clipping signal 250 onto the sub-space of the MIMO channel that the MIMO signal does not occupy is void. Thus, the MIMO signal 230 cannot be orthogonally transmitted with any part of the clipping signal 250 to achieve PAPR reduction without any EVM for the intended receiver.

FIG. 2C schematically illustrates example principles of PAPR reduction for MIMO transmission according to some embodiments. The exemplification illustrates rank-extension for a MIMO channel having only one signal path available for transmission (i.e., only one possible beamformed transmission direction) by letting a virtual receiver (VRX) 280 reside in a null space of the MIMO channel between the transmitter 210 and the intended receiver 220.

Part (a) of FIG. 2C illustrates a rank-extended MIMO signal comprising an intended receiver signal portion 231 on a beam directed towards the intended receiver, a virtual receiver signal portion 291 on a beam directed towards the virtual receiver, and a corresponding clipping signal for PAPR reduction of the rank-extended MIMO signal. The clipping signal comprises two parts 261, 262 on respective beams.

A first part of the clipping signal 261, which is a projection of the clipping signal onto the sub-space of the MIMO channel that the intended receiver signal portion of the MIMO signal occupies, appears on the same beam as the intended receiver signal portion 231 of the MIMO signal. A second part of the clipping signal 262, which is a projection of the clipping signal onto the sub-signal space of the MIMO channel that the intended receiver signal portion of the MIMO signal does not occupy, appears on a different beam than the intended receiver signal portion 231 of the MIMO signal; namely the same beam as the virtual receiver signal portion 291 of the MIMO signal.

Thus, by introduction of the virtual receiver, the MIMO channel is richened and a projection of the clipping signal onto the sub-signal space of the MIMO channel that the intended receiver signal portion of the MIMO signal does not occupy is no longer void (i.e., the projected clipping signal is non-zero) because there is now clipping energy in that sub-signal space of the MIMO channel.

Part (b) of FIG. 2C illustrates a PAPR reduced MIMO signal for transmission. The PAPR reduced MIMO signal is a combination of the intended receiver signal portion 231 of the MIMO signal, the virtual receiver signal portion 291 of the MIMO signal, and the second part of the clipping signal 262.

The signal combination of part (a) of FIG. 2C provides high PAPR reduction (due to inclusion of both parts 261, 262 of the clipping signal) but also high EVM for the intended receiver (due to the first part 261 of the clipping signal causing disturbance to the intended receiver signal portion 231 of the MIMO signal).

The signal combination of part (b) of FIG. 2C provides reasonably high PAPR reduction (due to inclusion of the second part 262 of the clipping signal), no EVM for the intended receiver (due to no part of the clipping signal causing disturbance to the intended receiver signal portion 231 of the MIMO signal), and high EVM for the virtual receiver (due to the second part 262 of the clipping signal causing disturbance to the virtual receiver signal portion 291 of the MIMO signal). However, the EVM for the virtual receiver is typically not problematic since the virtual receiver signal portion 291 of the MIMO signal is typically not intended for information transfer.

Thus, the approach exemplified by part (b) or FIG. 2C may be advantageous for transmission; in particular in the context of non-rich MIMO channels. Put more generally, this approach may be described as defining a rank-extended MIMO transmission towards the intended receiver 220 and a virtual receiver 280 (residing in the null space of the MIMO channel between the transmitter and the intended receiver) by generating a rank-extended MIMO signal comprising an intended receiver signal portion 231 and a virtual receiver signal portion 291, determining a clipping signal for the rank-extended MIMO signal, and generating a PAPR reduced MIMO signal by combining the rank-extended MIMO signal with a projection 262 of the clipping signal onto the null space of the MIMO channel. The rank-extension mitigates the situation illustrated in FIG. 2B, where an attempted PAPR reduction fails since the projection of the clipping signal onto the sub-signal space of the MIMO channel that the MIMO signal does not occupy is void.

Part (c) of FIG. 2C illustrates the principles of parts (a) and (b) of FIG. 2C in a schematic representation of the MIMO channel. The schematic representation of the MIMO channel has a single dimension; illustrated in a three-dimensional space spanned by corresponding basis vectors 201, 202, 203. The intended receiver signal portion 231 of the MIMO signal occupies the dimension spanned by the basis vector 201, as illustrated by 230. By introduction of the virtual receiver in the null space of the MIMO channel, a virtual receiver signal portion 291 of the MIMO signal occupies a dimension in the null space spanned by the basis vectors 202, 203, as illustrated by 290. Thereby, the clipping signal 260 is enabled to comprise a first part 261 and a second part 262. The first part 261 is a projection onto the sub-space of the MIMO channel that the intended receiver signal portion of the MIMO signal occupies, as illustrated by 268. The second part 262 is a projection onto the null space of the MIMO channel, as illustrated by 269. Thus, the intended receiver signal portion 230 of the MIMO signal and the second part 269 of the clipping signal may be orthogonally transmitted to achieve reasonably high PAPR reduction without any EVM for the intended receiver.

Generally, some embodiments enable massive-MIMO CFR algorithms to provide significant PAPR reduction by exploring the degrees of freedom provided by large antenna arrays to let the clipping noise reside in the channel null space (i.e., steer the clipping noise to directions where no intended receiver is impacted).

The principles of some embodiments will now be described and exemplified using a mathematical context. For this exemplification, it is assumed that the transmitter is comprised in a base station and that the intended receivers are comprised in user equipments (UEs).

A projection matrix Pₙ^{proj}∈ [symbol] ^{M×M} is utilized for enabling clipping noise to reside in the channel null space, where n∈{1, . . . , N} is the subcarrier index and M is the number of antennas at the base station. The projection matrix may be defined as Pₙ^{proj}=I−Pₙ^{ZF}Hₙ, where I is the M×M identity matrix, Hₙ∈ [symbol] ^{K×M} is the channel matrix for subcarrier n, where K is the number of MIMO layers, and Pₙ^{ZF}∈ [symbol] ^{M×K} is the zero-forcing (ZF) precoding matrix for subcarrier n.

The ZF precoding matrix may be expressed as Pₙ^{ZF}=Hₙ^{†}≡Hₙ^{H}(HₙHₙ^{H})⁻¹. It should be noted that use of ZF precoding is merely an example, and that other precoding approaches may be equally applicable. Other suitable precoding approaches include, for example, reciprocity-based precoding (e.g., sub-band singular value decomposition, SVD, precoding based on sounding reference signals, SRS) and feedback-based precoding (e.g., based on precoding matrix indicator, PMI, in channel state information, CSI, reports from UE).

The channel matrix Hₙ may be expressed in terms of its singular value decomposition (SVD) components as Hₙ=Uₙ·Σₙ·Vₙ^{H}, where Uₙ∈ [symbol] ^{K×K} contains the left singular vectors, Σₙ∈ [symbol] ^{K×M} is a diagonal matrix containing the singular values, and Vₙ∈ [symbol] ^{M×M} contains the right singular vectors (i.e., the M-dimensional basis of the channel for the intended receivers). It should be noted that use of SVD is merely an example, and that other matrix factorization approaches may be equally applicable. Other suitable matrix factorization approaches include, for example, eigen-decomposition (e.g., expressing the square matrix Hₙ^{H}Hₙ in terms of its eigenvalue components as Hₙ^{H}Hₙ=VₙΣₙ^{H}ΣₙVₙ^{H}).

The matrix Vₙ may also be expressed through an augmented matrix as Vₙ=[Vₙ^{UE}|Vₙ^{Null}], where Vₙ^{UE}∈ [symbol] ^{M×K} is the column span of the UE signal (i.e., of the signal for transmission to the intended receivers) in the Vₙ matrix—corresponding to the UE singular vectors (also known as the UE signal subspace, the signal space of the MIMO channel, or the signal space occupied by the intended receiver signal portion)—and Vₙ^{Null}∈ [symbol] ^{M×(M-K)} corresponds to the UE null space (also known as the null space of the MIMO channel, or the channel null space).

Substitution using the above-mentioned expressions yields the following equation for the projection matrix:

$$\begin{matrix}{P}_{n}^{proj} = I - {V}_{n} \cdot {Σ}_{n}^{H} \cdot {U}_{n}^{H} \cdot {( {U}_{n} \cdot {Σ}_{n} \cdot {V}_{n}^{H} \cdot {V}_{n} \cdot {Σ}_{n}^{H} \cdot {U}_{n}^{H} )}^{- 1} \cdot {U}_{n} \cdot {Σ}_{n} \cdot {V}_{n}^{H} \\ = I - {V}_{n} \cdot {Σ}_{n}^{H} \cdot {U}_{n}^{H} \cdot {( {U}_{n} \cdot {Σ}_{n} \cdot I \cdot {Σ}_{n}^{H} \cdot {U}_{n}^{H} )}^{- 1} \cdot {U}_{n} \cdot {Σ}_{n} \cdot {V}_{n}^{H} \\ = I - {V}_{n} \cdot {Σ}_{n}^{H} \cdot {U}_{n}^{H} \cdot {( {U}_{n} \cdot {Λ}_{n} \cdot {U}_{n}^{H} )}^{- 1} \cdot {U}_{n} \cdot {Σ}_{n} \cdot {V}_{n}^{H} \\ = I - {V}_{n} \cdot {Σ}_{n}^{H} \cdot {U}_{n}^{H} \cdot ( {U}_{n} \cdot {Λ}_{n}^{+} \cdot {U}_{n}^{H} ) \cdot {U}_{n} \cdot {Σ}_{n} \cdot {V}_{n}^{H} \\ = I - {V}_{n} \cdot {Σ}_{n}^{H} \cdot I \cdot {Σ}_{n} \cdot {V}_{n}^{H} \\ = I - {V}_{n} \cdot {\tilde{I}}_{K} \cdot {V}_{n}^{H} \\ = I - [ {V}_{n}^{UE} \vert {V}_{n}^{Null} ] \cdot {\tilde{I}}_{K} \cdot [ {V}_{n}^{UE} \vert {V}_{n}^{Null} ] \\ = {V}_{n}^{Null} \cdot {( {V}_{n}^{Null} )}^{H} ,\end{matrix}$$

where Λₙ∈ [symbol] ^{K×K} is the diagonal matrix of the eigenvalues Λₙ=Σₙ·Σₙ^{H}, and Λₙ⁺∈ [symbol] ^{K×K} is the inverse of the diagonal matrix Λₙ:

$${Λ}_{n}^{+} = [ \begin{matrix}1 / {λ}_{0 , n} & 0 & ⋯ & 0 \\ 0 & 1 / {λ}_{1 , n} & & ⋮ \\ ⋮ & & ⋱ & 0 \\ 0 & ⋯ & 0 & 1 / {λ}_{K - 1 , n}\end{matrix} ] .$$

Ĩ_{K} is an incomplete M×M identity matrix with only the first K diagonal entries equal to one and the remaining entries equal to zero.

Thus, the massive-MIMO CFR projection matrices Pₙ^{proj}=Vₙ^{Null}·(Vₙ^{Null})^{H} can exploit the channel nulls of the scheduled UEs (i.e., the null space of the MIMO channel for transmission to the intended receivers).

Using the exemplification of FIGS. 2A-C, the mathematical context described above may be visualized as follows, assuming that the intended receiver 220 is comprised in a UE.

Referring to FIG. 2A, wherein a rich channel is exemplified, the clipping signal 240 may be expressed as zₙ and comprises two parts; (Hₙ^{†}Hₙ)zₙ which corresponds to the first part 241, 248 and resides in the UE signal subspace, and (I−Hₙ^{†}Hₙ)zₙ which corresponds to the second part 242, 249 and resides in the channel null space. Spatial projection onto the null space removes the clipping signal part that is in the same direction as the UE (i.e., the first part 241, 248), and leaves only the clipping signal part (I−Hₙ^{†H}ₙ)zₙ (i.e., the second part 242, 249); thereby providing PAPR reduced transmission with zero EVM for the UE.

Referring to FIG. 2B, wherein a frequency-flat channel is exemplified, the clipping signal 250, 251 comprises only one part; (Hₙ^{†}Hₙ)zₙ which resides in the UE signal subspace. Typically, this is due to that no intermodulation terms are provided by Hₙ^{†}Hₙ, When there is only a LoS component in the channel Hₙ. This is particularly prominent for rank-1 transmission. Spatial projection onto the null space removes this clipping signal part, and leaves no clipping signal at all; thereby failing to provide any PAPR reduction.

This is because the clipping operation (which is conventionally a non-linear type operator) behaves like a linear operator under these circumstances, thereby failing to spread the clipping noise in different directions. Thus, the clipping signal may be expressed as zₙ=Hₙ^{†}rₙ, where rₙ represents a vector, and a projection onto the channel null space becomes (I−Hₙ^{†}Hₙ)zₙ=Hₙ^{†}rₙ−Hₙ^{†}HₙHₙ^{†}rₙ=0.

Referring to FIG. 2C, the frequency-flat channel exemplified in FIG. 2B is richened by introduction of a virtual receiver (i.e., by introduction of an additional MIMO layer) according to some embodiments. The additional MIMO layer(s) may be precoded using selected singular vectors from the channel null space, which may be represented by a matrix Vₙ^{VAN} having the selected singular vectors as columns. Thereby, the clipping signal 260 is enabled to comprise two parts; (Hₙ^{†}Hₙ)zₙ which corresponds to the first part 261, 268 and resides in the UE signal subspace, and (I−Hₙ^{†}Hₙ)zₙ which corresponds to the second part 262, 269 and resides in the channel null space as made available by introduction of the virtual receiver. It should be noted that, even though the channel is enriched so that Hₙ^{†} is expanded to [Hₙ^{†}|Vₙ^{VAN}], the inverse remains unchanged. Therefore, the virtual receiver approach may be seen as transparent to massive-MIMO CFR algorithms. Spatial projection onto the null space removes the clipping signal part that is in the same direction as the UE (i.e., the first part 261, 268), and leaves only the second part 262, 269; thereby providing PAPR reduced transmission with zero EVM for the UE even though the channel is frequency-flat.

Returning to the general mathematical context exemplifying some embodiments, one step of realizing the VAN framework comprises identifying one or more singular vectors (nulls) from the Pₙ^{proj} projection matrices. This may be seen as part of step 140 of the method 100 described in connection to FIG. 1. The number of singular vectors may correspond to the number of VANs that are to be introduced, and the singular vectors may be based on the directions in which it is desirable to steer the clipping noise.

For example, when K′ additional MIMO layers (corresponding to K′ VANs) are to be introduced for the n^{th} subcarrier, a selection may be made (e.g., randomly) of K′ columns \tilde{v}ₙ^{k′}, k′=1, 2, . . . , K′ from the matrix Vₙ^{Null} to virtually locate the VANs in the null space of the MIMO channel. In some embodiments, the selection is based on the directions in which it is desirable to steer the clipping noise. It should be noted that the selected columns may be different for different subcarriers. This may emulate frequency-selectivity of the channel and cause the clipping to behave nonlinearly.

The selected columns may be regarded as precoding vectors, and may be stacked to form a precoding matrix Vₙ^{VAN}∈ [symbol] ^{M×K′} for the additional MIMO layers: Vₙ^{VAN}=[\tilde{v}ₙ¹, \tilde{v}ₙ², . . . , \tilde{v}ₙ^{K′}].

Another step of realizing the VAN framework comprises generating an antenna-domain signal xₙ∈ [symbol] ^{M×1} for the n^{th} subcarrier. This may be seen as part of step 160 of the method 100 described in connection to FIG. 1.

For example, the signal sₙ∈ [symbol] ^{K×1} comprising traffic for the intended receivers (i.e., the intended receiver signal portion) may be augmented by the signal s′ₙ∈ [symbol] ^{K′×1} comprising VAN traffic (i.e., the virtual receiver signal portion), and the user precoding matrix Hₙ^{†}∈ [symbol] ^{M×K} may be augmented with the VAN precoding matrix Vₙ^{VAN}∈ [symbol] ^{M×K′}. Then, the antenna-domain signal xₙ∈ [symbol] ^{M×1} may be generated by performing a matrix-vector multiplication for the two augmented variables: xₙ=[Hₙ^{†}|Vₙ^{VAN}][sₙ^{T}|s′ₙ^{T}]^{T}.

The antenna-domain signal xₙ may be provided as an input to a MIMO CFR algorithm for further processing. This may be seen as part of step 180 of the method 100 described in connection to FIG. 1. The further processing may comprise determination of a clipping signal for the antenna-domain signal xₙ (compare with step 182 in FIG. 1) and generation of a PAPR reduced MIMO signal via null space projection of the clipping signal (compare with step 184 in FIG. 1). It may be noted that application of the VAN framework is transparent to the MIMO CFR algorithm according to some embodiments.

In some embodiments, the power that is allocated to the VANs (i.e., to the additional MIMO layers) is configurable and may be controlled by a parameter α∈ [symbol] ₊^{K′×1}, which may be the same or different for different VANs. This may be seen as part of step 150 of the method 100 described in connection to FIG. 1. Then, the antenna-domain signal xₙ∈ [symbol] ^{M×1} for the n^{th} subcarrier may be expressed as xₙ=[Hₙ^{†}|Vₙ^{VAN}][sₙ^{T}|(diag(α)·s′ₙ)^{T}]^{T}.

In some scenarios, the previously presented equation for the projection matrix Pₙ^{proj} may produce rank deficient projection matrices. In such cases, a new orthonormal basis (i.e., an alternative vector basis) Vₙ^{proj} may be generated, typically based on the projection matrix Pₙ^{proj} and/or on the orthonormal basis Vₙ^{Null} (i.e., the vector basis representing the null space of the MIMO channel). For example, the projection matrix Pₙ^{proj} may be eigen-decomposed to generate the new orthonormal basis. This may be seen as part of steps 125 and 130 of the method 100 described in connection to FIG. 1. Typically, the new orthonormal basis is generated to offer a finer spatial resolution than Vₙ^{Null}, and K′ columns \tilde{v}ₙ^{k′} may be selected from the matrix Vₙ^{proj} to virtually locate the VANs in the null space of the MIMO channel.

As already mentioned, the clipping signal may be slightly leaked into the signal space of the MIMO channel according to some embodiments; by application of a weighted projection of the clipping signal onto the signal space of the MIMO channel (compare with step 170 of the method 100 described in connection to FIG. 1). The weighting factor may be denoted by δϵ[0,1] and may, for example, depend on the modulation and coding scheme (MCS). In the context of the general mathematical context exemplifying some embodiments, the leakage may be represented by introducing weighting factor into the previously presented equation for the projection matrix, resulting in Pₙ^{proj}=I−Vₙ^{UE}·Δₙ·(Vₙ^{UE})^{H}, where Δₙ is a diagonal matrix of size K×K having the weighting factors δₖ for the K MIMO layers, k=1,2, . . . , K, as diagonal elements.

In some embodiments, the power allocation parameter α, the weighting factor δ, and the CFR clipping threshold are jointly optimized; e.g., to enable maximum link-level performance depending on MCS and channel state information (CSI) or the intended receivers.

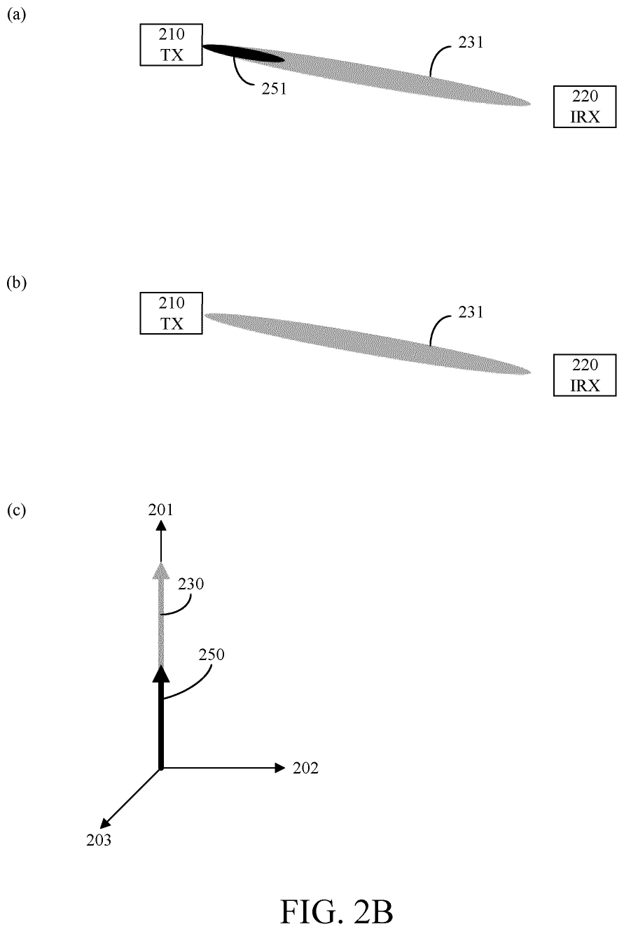

FIG. 3 schematically illustrates an example apparatus 300 according to some embodiments; which may be regarded as providing an example overview of the VAN framework for MIMO CFR. The apparatus 300 may, for example, be configured to perform one or more method steps as described above (e.g., in connection with FIG. 1). In some embodiments, the apparatus 300 is configured to perform—at least—step 180 of the method 100 described in connection to FIG. 1.

For each of N subcarriers, the signal sₙ∈ [symbol] ^{K×1} (i.e., the intended receiver signal portion) 301, 305 is provided as input together with the signal s′ₙ∈ [symbol] ^{K′×1} (i.e., the virtual receiver signal portion) 302, 306. The power allocated to the virtual receiver signal portion may be variable, as illustrated by multipliers 303, 304, 307, 308. For each subcarrier, the intended receiver signal portion is subjected to intended receiver precoding (IPC; e.g., representable by Hₙ^{†}) 311, 315, and the virtual receiver signal portion is subjected to virtual receiver precoding (VPC; e.g., representable by Vₙ^{VAN}) 312, 316. The resulting precoded vectors of length M are combined 321, 325 for each subcarrier to form the antenna-domain signal xₙ. The antenna-domain signals of all subcarriers may be subjected to re-ordering (RO) 330 before application of an inverse fast Fourier transform (IFFT) 341, 349 to provide time-domain signals for the M antennas. The time-domain signals may be up-sampled (US) 351, 359 before being input to a massive-MIMO CFR 360, which outputs an M-dimensional PAPR reduced MIMO signal 370 for transmission.

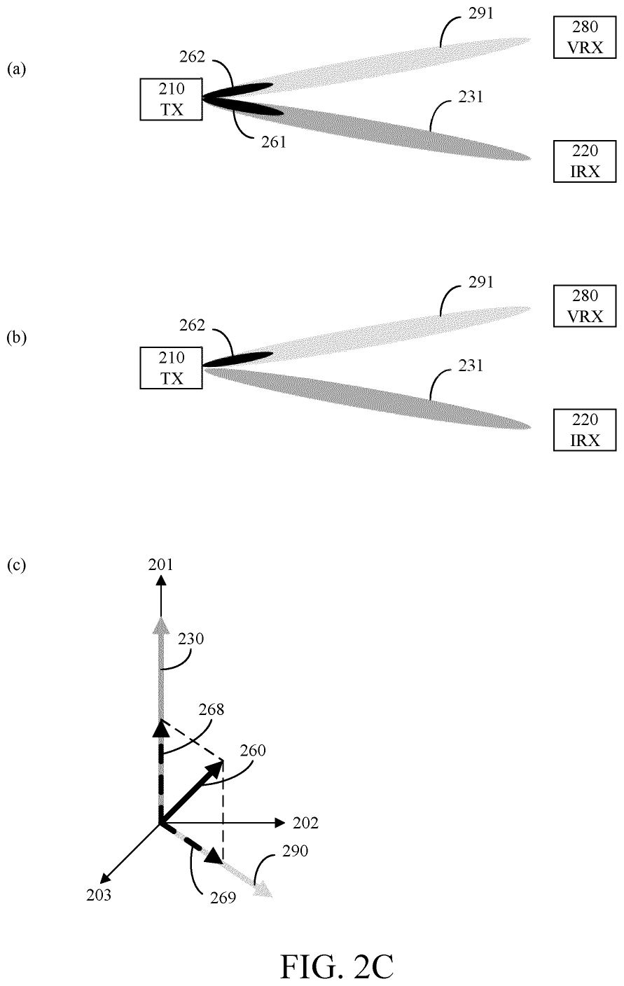

In some embodiments, the VAN framework for MIMO CFR may be deployed as a standalone radio feature in an open radio access network (O-RAN) radio unit (O-RU). FIG. 4 schematically illustrates an example apparatus 400 for this purpose; in the context of an O-RU 499 (e.g., an O-RU Category B). The apparatus 400 may, for example, be configured to perform one or more method steps as described above (e.g., in connection with FIG. 1). In some embodiments, the apparatus 400 is configured to perform the method 100 described in connection to FIG. 1.

Adaptation to deployment in O-RU may comprise introducing some additive perturbations to the baseband signal that is provided by the O-RAN distributed unit (O-DU): xₙ=zₙ−Pₙ^{ZF} (Hₙzₙ−sₙ)=(I−Pₙ^{ZF}Hₙ)·zₙ+Pₙ^{ZF}·sₙ.

When the apparatus 400 is used, the signal sₙ (i.e., the intended receiver signal portion) 401, 405 is provided as input for each of N subcarriers; typically from O-DU. Precoder matrices Pₙ (ZF precoder matrices Pₙ^{ZF} used for exemplification) 471,475 are typically also provided from O-DU, and are applied to the input signal by the intended receiver precoding (IPC) 402, 408 to produce xₙ^{ZF}.

The virtual receiver signal portion is produced by VAN traffic Generators (VTG) 403, 406 (e.g., using default traffic, random traffic, or copied traffic from the one or more intended receiver).

For the N subcarriers, the projection matrix Pₙ^{proj} for updating of xₙ is provided by a weight computation unit (WCU) 474, 478.

The coefficients of the projection matrix Pₙ^{proj} may be acquired by different approaches; two of which are illustrated in FIG. 4. One approach comprises sniffing of the common public radio interface (CPRI) signal subspace, as illustrated by signal subspace tracker (ST) 472, 476. One approach comprises (over-the-air) reception of signal subspace estimation from the intended receiver(s), as illustrated by signal subspace receiver (SR) 473, 477; including identification of a suitable channel null space. These two approaches may be used in combination for more robust null space estimation. The Pₙ^{proj} projection matrices 481, 485 for each of the N subcarriers are then provided to the massive-MIMO CFR algorithm 460.

Additionally, the WCU 474 and 478 may also generate the virtual receiver signal portion beamforming weights 482, 486 that are provided to the virtual receiver precoding (VPC) units 404 and 407.

Similarly to the example of FIG. 3, the intended receiver signal portion is subjected to intended receiver precoding (IPC) 402, 408, and the virtual receiver signal portion is subjected to virtual receiver precoding (VPC) 404, 407.

The resulting precoded vectors of length M are combined 421, 425 for each subcarrier to form the antenna-domain signal xₙ. The antenna-domain signals of all subcarriers may be subjected to re-ordering (RO) 430 before application of an inverse fast Fourier transform (IFFT) 441, 449 to provide time-domain signals for the M antennas. The time-domain signals may be up-sampled (US) 451, 459 before being input to a massive-MIMO CFR 460, which outputs an M-dimensional PAPR reduced MIMO signal 490 for transmission.

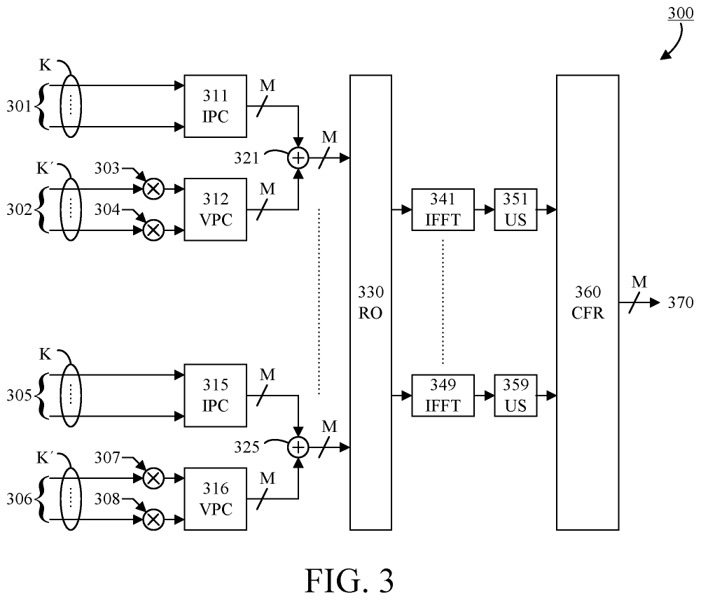

FIG. 5 schematically illustrates an example apparatus 500 according to some embodiments. The apparatus 500 is for reduction of peak-to-average power ratio (PAPR) of transmission using multiple-input multiple-output (MIMO) from a transmitter.

For example, the apparatus 500 may comprise, or may be comprised in, or may be configured to control, any of the apparatuses 300 and 400 described in connection to Figured 3 and 4. Alternatively or additionally, the apparatus may be configured to cause performance of (e.g., perform) one or more method steps as described above (e.g., in connection with FIG. 1).

In some embodiments, the apparatus 500 is comprised (or comprisable) in a communication device 510. For example, the communication device 510 may be a radio access node, a user device, or a control node. When the communication device 510 is a radio access node, or a user device, the communication device 510 may also comprise the transmitter (TX; e.g., transmission circuitry or a transmission module) 530. When the communication device 510 is a control node, the transmitter may be comprised in another communication device (e.g., a radio access node controlled by the control node).

The apparatus comprises a controller (CNTR; e.g., controlling circuitry, or a control module) 520.

The controller 520 is configured to cause definition of a rank-extended MIMO transmission towards one or more intended receivers and one or more virtual receivers, wherein the one or more virtual receivers reside in a null space of a MIMO channel between the transmitter and the one or more intended receivers (compare with step 140 of FIG. 1).

To this end, the controller may comprise, or be otherwise associated with (e.g., connected, or connectable, to), a definer (DEF; e.g., defining circuitry, or a definition module) 521. The definer 521 may be configured to define the rank-extended MIMO transmission.

The controller 520 is also configured to cause generation of a rank-extended MIMO signal for the rank-extended MIMO transmission, wherein the rank-extended MIMO signal comprises an intended receiver signal portion and a virtual receiver signal portion (compare with step 160 of FIG. 1).

To this end, the controller may comprise, or be otherwise associated with (e.g., connected, or connectable, to), a generator (GEN; e.g., generating circuitry, or a generation module) 522. The generator 522 may be configured to generate the rank-extended MIMO signal.

The controller 520 is also configured to cause determination of a clipping signal for the rank-extended MIMO signal (compare with step 182 of FIG. 1) and generation of a PAPR reduced MIMO signal by combining the rank-extended MIMO signal with a projection of the clipping signal onto the null space of the MIMO channel (compare with step 184 of FIG. 1).

To this end, the controller may comprise, or be otherwise associated with (e.g., connected, or connectable, to), a crest factor reducer (CFR; e.g., crest factor reducing circuitry, or a crest factor reduction module; compare with the CFR 360 of FIG. 3, and the CFR 460 of FIG. 4) 523. The CFR 523 may be configured to determine the clipping signal and generate the PAPR reduced MIMO signal (compare with step 180 of FIG. 1). In some embodiments, the CFR 523 comprises a determiner configured to determine the clipping signal and a generator configured to generate the PAPR reduced MIMO signal.

The controller 520 may also be configured to cause transmission of the PAPR reduced MIMO signal over the MIMO channel (compare with step 190 of FIG. 1).

To this end, the controller may comprise, or be otherwise associated with (e.g., connected, or connectable, to), the transmitter (TX; e.g., transmitting circuitry, or a transmission module) 530. The transmitter 530 may be configured to transmit the PAPR reduced MIMO signal over the MIMO channel.

Alternatively or additionally, the controller 520 may also be configured to cause allocation of power to the one or more virtual receivers (compare with step 150 of FIG. 1).

To this end, the controller may comprise, or be otherwise associated with (e.g., connected, or connectable, to), an allocator (ALL; e.g., allocating circuitry, or an allocation module) 524. The allocator 524 may be configured to allocate power to the one or more virtual receivers.

Alternatively or additionally, the controller 520 may also be configured to cause determination of a weighting factor for leakage of the clipping signal (compare with step 170 of FIG. 1).

To this end, the controller may comprise, or be otherwise associated with (e.g., connected, or connectable, to), a determiner (DET; e.g., determining circuitry, or a determination module) 525. The determiner 525 may be configured to determine the weighting factor.

Alternatively or additionally, the controller 520 may also be configured to cause generation of an alternative vector basis for the null space responsive to the projection matrix being rank-deficient (compare with steps 125 and 130 of FIG. 1).

To this end, the controller may comprise, or be otherwise associated with (e.g., connected, or connectable, to), an alternative vector basis generator (AVB; e.g., generating circuitry, or a generation module) 525. The alternative vector basis generator 526 may be configured to generate the alternative vector basis.

In some embodiments, the controller 520 is configured to cause the definition of the rank-extended MIMO transmission, the generation of the rank-extended MIMO signal, the determination of the clipping signal, and the generation of the PAPR reduced MIMO signal to be executed only when the MIMO channel fulfills a frequency flatness condition (compare with steps 110 and 120 of FIG. 1).

To this end, the controller may comprise, or be otherwise associated with (e.g., connected, or connectable, to), a switcher (SW; e.g., switching circuitry, or a switch module) 527. The switcher 527 may be configured to determine whether the frequency flatness condition is fulfilled and control the operation accordingly. For example, responsive to the frequency flatness condition being fulfilled, the switcher may set the controller 520 to operate in a first mode where virtual receiver(s) are applied as explained herein. In some embodiments, the switcher may set the controller 520 to operate in a second mode responsive to the frequency flatness condition being fulfilled, wherein virtual receiver(s) are not applied.

As already mentioned, the transmitter may be comprised in another communication device when the communication device 510 is a control node. Then, the controller 520 may be configured to cause some of the actions described above to be performed by the control node, and cause other ones of the actions described above to be performed by the other device. For example, the control node may be configured to perform actions corresponding to steps 140, 160, 182, 184 of FIG. 1, and to cause the other device to perform actions corresponding to step 190 of FIG. 1; or the control node may be configured to perform actions corresponding to steps 140, 160 of FIG. 1, and to cause the other device to perform actions corresponding to steps, 182, 184, 190 of FIG. 1.

It should be noted that any features described elsewhere in this description (e.g., in connection with FIG. 1) are equally applicable to the apparatus 500 of FIG. 5, even if not explicitly mentioned in connection thereto.

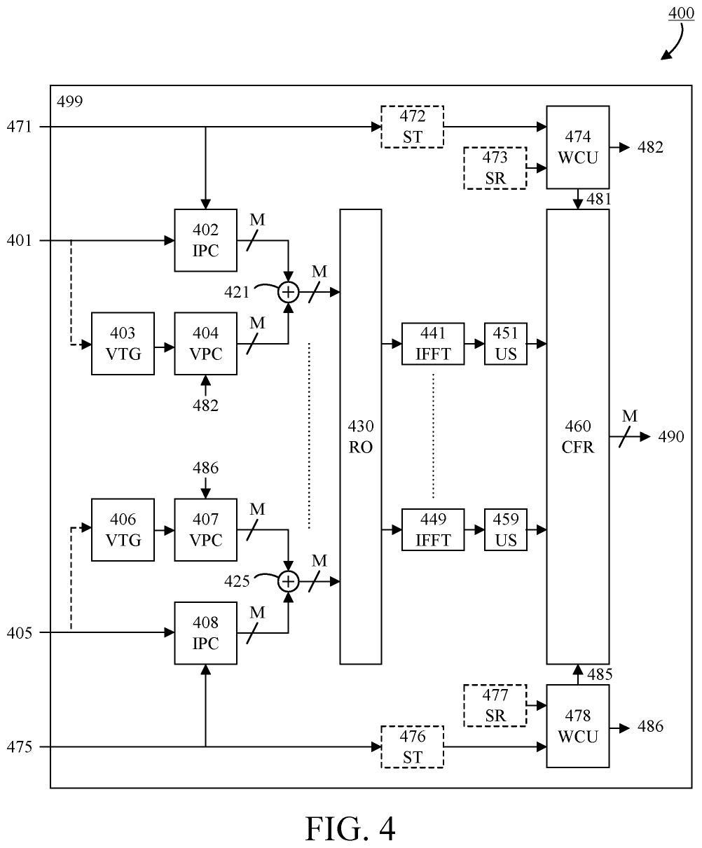

FIG. 6 schematically illustrates an example system 600 according to some embodiments. The system 600 comprises a plurality of radio access nodes 610, 611, 612, and a control node (CN; e.g., a central network node, a cloud server, or an edge computing node) 620.

The control node 620 is configured to control one or more of the radio access nodes 610, 611, 612 for PAPR reduction of MIMO transmission from a transmitter of the controlled radio access node. For example, the control node 620 may comprise the apparatus 500 as described in connection with FIG. 5.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a communication device (e.g., a radio access node, a user device, or a control node).

Embodiments may appear within an electronic apparatus (such as a communication device) comprising arrangements, circuitry, and/or logic according to any of the embodiments described herein. Alternatively or additionally, an electronic apparatus (such as a communication device) may be configured to perform methods according to any of the embodiments described herein.

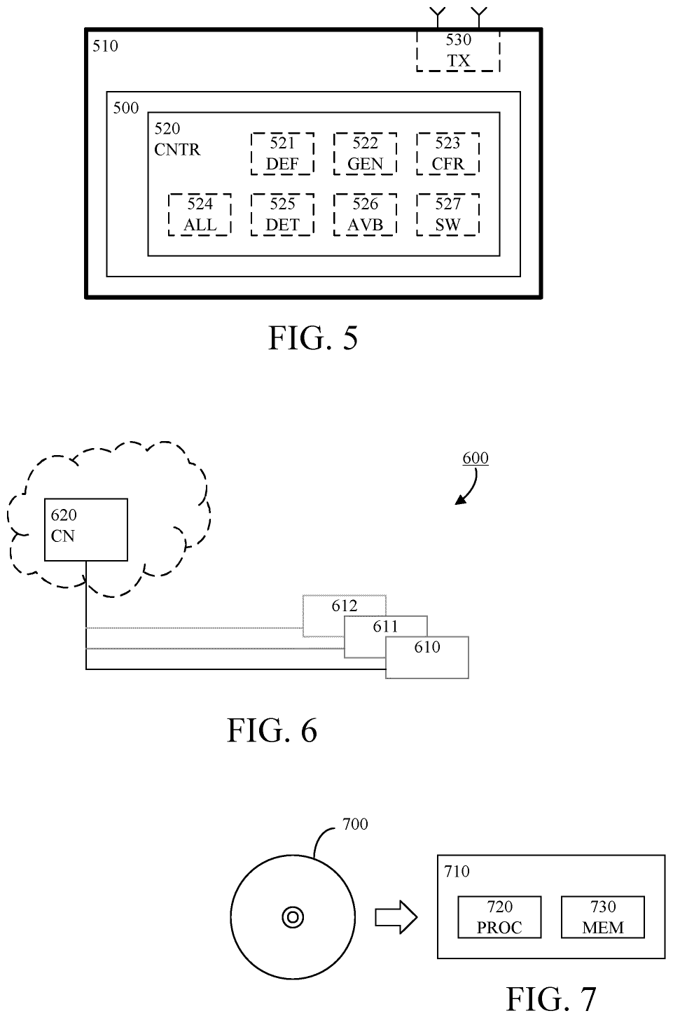

According to some embodiments, a computer program product comprises a non-transitory computer readable medium such as, for example, a universal serial bus (USB) memory, a plug-in card, an embedded drive, or a read only memory (ROM). FIG. 7 illustrates an example computer readable medium in the form of a compact disc (CD) ROM 700. The computer readable medium has stored thereon a computer program comprising program instructions. The computer program is loadable into a data processor (PROC; e.g., a data processing unit) 720, which may, for example, be comprised in a communication device 710. When loaded into the data processor, the computer program may be stored in a memory (MEM) 730 associated with, or comprised in, the data processor. According to some embodiments, the computer program may, when loaded into, and run by, the data processor, cause execution of method steps according to, for example, the method illustrated in FIG. 1, or as otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-49. (canceled)

50. A method for reduction of peak-to-average power ratio, PAPR, of transmission using multiple-input multiple-output, MIMO, from a transmitter, the method comprising:
defining a rank-extended MIMO transmission towards one or more intended receivers and one or more virtual receivers, wherein the one or more virtual receivers reside in a null space of a MIMO channel between the transmitter and the one or more intended receivers;
generating a rank-extended MIMO signal for the rank-extended MIMO transmission, wherein
the rank-extended MIMO signal comprises an intended receiver signal portion and a virtual receiver signal portion;
determining a clipping signal for the rank-extended MIMO signal; and
generating a PAPR reduced MIMO signal by combining the rank-extended MIMO signal with a projection of the clipping signal onto the null space of the MIMO channel.

51. A computer program product comprising a non-transitory computer readable medium, having thereon a computer program comprising program instructions, the computer program being loadable into a data processing unit and configured to cause execution of the method according to claim 50 when the computer program is run by the data processing unit.

52. An apparatus for reduction of peak-to-average power ratio, PAPR, of transmission using multiple-input multiple-output, MIMO, from a transmitter, the apparatus comprising controlling circuitry configured to cause:
definition of a rank-extended MIMO transmission towards one or more intended receivers and one or more virtual receivers, wherein the one or more virtual receivers reside in a null space of a MIMO channel between the transmitter and the one or more intended receivers;
generation of a rank-extended MIMO signal for the rank-extended MIMO transmission, wherein the rank-extended MIMO signal comprises an intended receiver signal portion and a virtual receiver signal portion;
determination of a clipping signal for the rank-extended MIMO signal; and
generation of a PAPR reduced MIMO signal by combining the rank-extended MIMO signal with a projection of the clipping signal onto the null space of the MIMO channel.

53. The apparatus of claim 52, wherein the controlling circuitry is further configured to cause transmission of the PAPR reduced MIMO signal over the MIMO channel.

54. The apparatus of claim 52, wherein respective directions from the transmitter towards the one or more virtual receivers are different, and/or wherein respective directions from the transmitter towards the one or more virtual receivers are variable between different subcarriers.

55. The apparatus of claim 52, wherein respective directions from the transmitter towards the one or more virtual receivers avoid a direction from the transmitter towards an interference sensitive device.

56. The apparatus of claim 52, wherein at least one of the one or more virtual receivers resides in a direction from the transmitter towards an energy harvesting device.

57. The apparatus of claim 52,
wherein the null space of the MIMO channel is representable by a vector basis, and wherein the controlling circuitry is configured to cause the definition of the rank-extended MIMO transmission by causing, for each of the one or more virtual receivers, selection of one or more base vectors from the vector basis for beamforming of signal components for the corresponding virtual receiver, or
wherein the null space of the MIMO channel is representable by a vector basis associated with a projection matrix, and wherein the controlling circuitry is configured to cause the definition of the rank-extended MIMO transmission by causing—responsive to the projection matrix being rank-deficient—generation of an alternative vector basis for the null space and, for each of the one or more virtual receivers, selection of one or more base vectors from the alternative vector basis for beamforming of signal components of the corresponding virtual receiver.

58. The apparatus of claim 57, wherein the selection of one or more base vectors is variable between the one or more virtual receivers and/or between different subcarriers.

59. The apparatus of claim 52, wherein the virtual receiver signal portion comprises one or more of: default traffic, random traffic, and copied traffic intended for the one or more intended receivers.

60. The apparatus of claim 52, wherein the controlling circuitry is configured to cause the definition of the rank-extended MIMO transmission, the generation of the rank-extended MIMO signal, the determination of the clipping signal, and the generation of the PAPR reduced MIMO signal to be executed only when the MIMO channel fulfills a frequency flatness condition.

61. The apparatus of claim 52, wherein a number of virtual receivers increases when magnitude variance between frequencies of the MIMO channel decreases.

62. The apparatus of claim 52, wherein power allocated to the one or more virtual receivers increases when magnitude variance between frequencies of the MIMO channel decreases, and/or wherein power allocated to the one or more virtual receivers increases when power allocated to the one or more intended receivers decreases, and/or wherein power allocated to the one or more virtual receivers is variable between the one or more virtual receivers and/or between different subcarriers.

63. The apparatus of claim 52, wherein generation of the PAPR reduced MIMO signal comprises combining the rank-extended MIMO signal with the projection of the clipping signal onto the null space of the MIMO channel, and with a projection—scaled by a weighting factor—of the clipping signal onto a signal space of the MIMO channel.

64. The apparatus of claim 63, wherein the weighting factor increases when a minimum distance between symbols of a coding and modulation alphabet increases, and/or wherein the weighting factor increases when magnitude variance between frequencies of the MIMO channel decreases, and/or wherein the weighting factor is variable between the one or more intended receivers and/or between different subcarriers, and/or wherein the weighting factor and power allocated to the one or more virtual receivers are selected jointly.

65. The apparatus of claim 64, wherein the weighting factor and power allocated to the one or more virtual receivers are selected jointly, and wherein the joint selection also comprises selection of maximal magnitude of the clipping signal, wherein the maximal magnitude of the clipping signal decreases when magnitude variance between frequencies of the MIMO channel decreases.

66. A radio access node comprising the apparatus of claim 52.

67. A user device comprising the apparatus of claim 52.

68. A control node comprising the apparatus of claim 52.

69. A system comprising a radio access node and a control node according to claim 68, wherein the control node is configured to control the radio access node for PAPR reduction of MIMO transmission from a transmitter of the radio access node.
